(19) United States
(12) Patent Application Publication
(10) Pub. No.: US 2005/0065643 A1
(43) Pub. Date: Mar. 24, 2005

(54) Method and apparatus for recovery of prohibited items

(76) Inventor: Daniel A. Elefante, Palm Beach Gardens, FL (US)

Correspondence Address: Michael A. Slavin, Esq.;McHale & Slavin, P.A., 2855 PGA Boulevard, Palm Beach Gardens, FL, 33410, US

(21) Appl. No.: 10/671,148

(22) Filed: Sep. 22, 2003

(51) Int. Cl. G06F 17/00

(52) U.S. Cl. 700/231

(57) ABSTRACT

In order for passengers of common carriers to enter into secure areas, they are subjected to a personal search to discover the presence of prohibited items. The prohibited items may be confiscated, if other arrangements cannot be made for disposal of them. In order for the possession of these items to remain with the passenger, a kiosk is placed in the immediate vicinity of the security check point. The kiosk may be manned or unmanned and contains the materials and devices necessary to ship the item to a desired location. The kiosk may include a bomb proof depository, a camera, a microphone, and a computer with keyboard. The kiosk also has a cash drawer and electronic card readers to complete the financial transaction.

### BACKGROUND OF THE INVENTION

1. Field of the Invention

This invention relates to anti-terrorism procedures and, particularly, to retrieval of items prohibited from passage through security screening devices at airports and other locations. Provision is made for shipping prohibited items to any address desired by the possessor of the items in lieu of confiscation.

2. Description of the Prior Art

The prior art is crowded with many different manual and automated devices by which people may ship items to any designated location. Such organizations as the U.S. Postal Service, FedEx and UPS, among others, owe their existence to providing this service to the public, at large. Part of the success of these organizations results from the convenience of the many locations available to the public to leave packages and parcels for shipment.

U.S. Published application No. US 2002/0156645 A1, published Oct. 24, 2002, teaches a kiosk and method of use that provides interaction between the sender, recipient and delivery service that increases the convenience of the conventional shippers. The kiosk is computer controlled for access of the designated personnel in addition to record keeping and tracking of packages.

U.S. Published application No. US 2003/0100973 A1, published May 29, 2003, and US 2003/0120510 A1, published Jun. 26, 2003, teach systems by which an airline passenger may arrange transportation of his baggage separate from his person thereby alleviating some security procedures now required at all airports.

U.S. Pat. No. 4,137,567, issued Jan. 30, 1979 teaches a computer controlled system verifying passengers and their baggage, transporting the baggage to the plane and performing security checks. Other prior art teaches different systems to match baggage with passengers and systems allowing passengers to check their own baggage.

All these prior art systems are concerned with the checked parcels going on the same plane or on other planes to arrive with the owner.

Since the inception of the TSA (Transportation Security Agency), passengers and everything carried on their persons are subject to security screening, by X-ray, chemical and visual inspections before boarding an airline flight. These inspections are directed to the discovery of any one of a long list of prohibited items not allowed on airline flights. The prohibited items are subject to confiscation, if the passenger cannot make arrangements to rid himself of them before clearing the check-point. The TSA personnel have some latitude in deciding whether or not items, not on the list should be allowed to pass through the security check points. This creates some uncertainty as to what may or may not be carried on board, for example, an item may be carried on one flight and confiscated by the TSA screeners on the next flight.

What is needed in the art is a system whereby a passenger may deposit a prohibited item or an item he thinks may be prohibited without leaving the check-point or the vicinity of the check-point.

### SUMMARY OF THE PRESENT INVENTION

There is a probability that some people attempt to clear a security check point without surrendering or acknowledging the possession of certain items simply because they do not want to lose the item and it is inconvenient or impossible to make other immediate arrangements. By providing an apparatus and method for quickly and easily depositing potentially prohibited items, the number of dangerous items carried on a given flight and the number of items confiscated by the security personnel will decrease in number. By reducing the number of potentially dangerous items to be checked, the total number of prohibited items will decline and the security screening will be more accurate.

Therefore, it is an objective of this invention to teach the use of a kiosk located at or near a security check-point in an airport to deposit items for separate shipment to an address of his choosing.

It is another objective of this invention to teach the use of a manned or unmanned package drop with materials for address labeling of items deposited therein. The kiosk may be equipped with devices to record a visual record of the transaction or audio-visual devices for shipping instructions.

It is a further objective of this invention to teach a tamper-proof and reinforced depository which is accessible by designated personnel, only.

It is a still further objective of this invention to teach a depository with apparatus for local transport of deposited items for remote handling and shipping.

It is another objective of this invention to teach the use of a forwarding service that will deliver the deposited item to the owner's home address or to the destination address or other desired address by an independent carrier from the airline flight of the owner.

### SHORT DESCRIPTION OF THE DRAWINGS

FIG. 1 is a representation of a floor plan for the preferred location of a kiosk of this invention;

FIG. 2 is a cross section of one embodiment of the kiosk of this invention; and

FIG. 3 is a cross section of another embodiment of this invention.

### DETAILED DESCRIPTION OF THE INVENTION

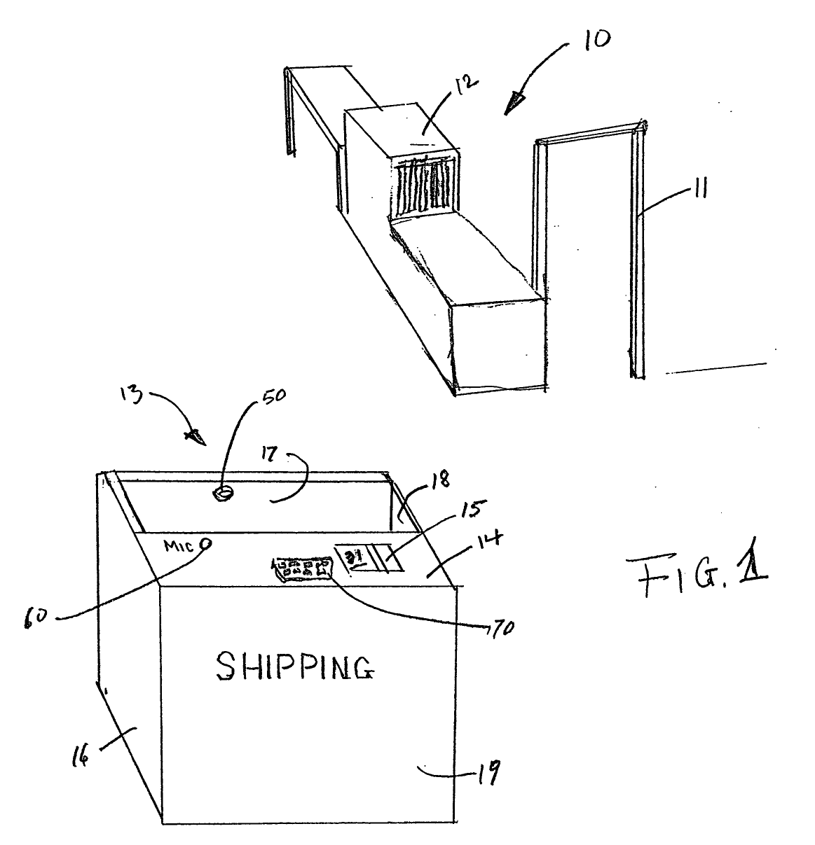

As illustrated in FIG. 1, the kiosk 13 is in the immediate vicinity of the security check-in station 10 of an airport or other facility that requires a passenger security search before boarding or entering a secure area. Common carriers, such as airlines, trains, ships, buses may have security check points to separate the passengers from the public. As shown, the security station 10 includes a magnetometer or metal detector 11 and an X-ray table 12. Other chemical, radiation and biological testing devices may also be a part of the security testing. The obvious purpose of these machines is to alert the security personnel to the presence of dangerous items that might be used as weapons. The security personnel must then prevent entry of the device into the secure area.

The person in possession of the prohibited item may be asked to surrender the device or remove the device before entry into the secure area will be allowed. This presents a dilemma of either allowing the item to be confiscated or leaving the security process and finding alternate storage for the item. One alternative, is to return to the airline check-in counter and have the item added to the flight and passenger as checked baggage. Another, is to return to a parked automobile, if one is available, and leave the item in the car. Both these alternatives may take considerable time and trouble. There may not be enough time left before departure to accomplish these courses of action.

Usually, these prohibited items are small, unobtrusive and, simply, overlooked by the passenger but may have high value, either monetarily or sentimentally. The location and function of the kiosk 13 facilitates a solution to the dilemma by affording a passenger the opportunity to make arrangements for the prohibited item without leaving the security checkpoint.

The kiosk 13 may be manned by an attendant or unmanned. The kiosk may be supplied with suitable packaging materials and labels to properly wrap and mark the destination of the enclosed item. The kiosk may provide a visual record of the transaction by use of a camera 50, such as a fish-eye to burn a CD or tape the passenger and the item being deposited. The camera may be operated by the attendant, the passenger or automatically. Such a record may be used as an element of the tracking system to insure that the correct item is received by the right person. Of course, security personnel could view the tape in the event of reasonable cause.

Another feature, is a microphone 60 connected to a tape which may be used in place of labels and writing tools. With this embodiment, the kiosk may be supplied with numbered and/or bar coded shipping containers. The passenger would only have to deposit the item, say the number or bar code of the container and the address to which the contents is to be sent. A brief description of the contents may also be given audibly. After deposit, the items would be removed from the kiosk by authorized personnel, properly packed and labeled for transhipment.

A keyboard 70 may be attached to the counter. The keyboard may be connected to a computer that is capable of printing labels with input from the passenger.

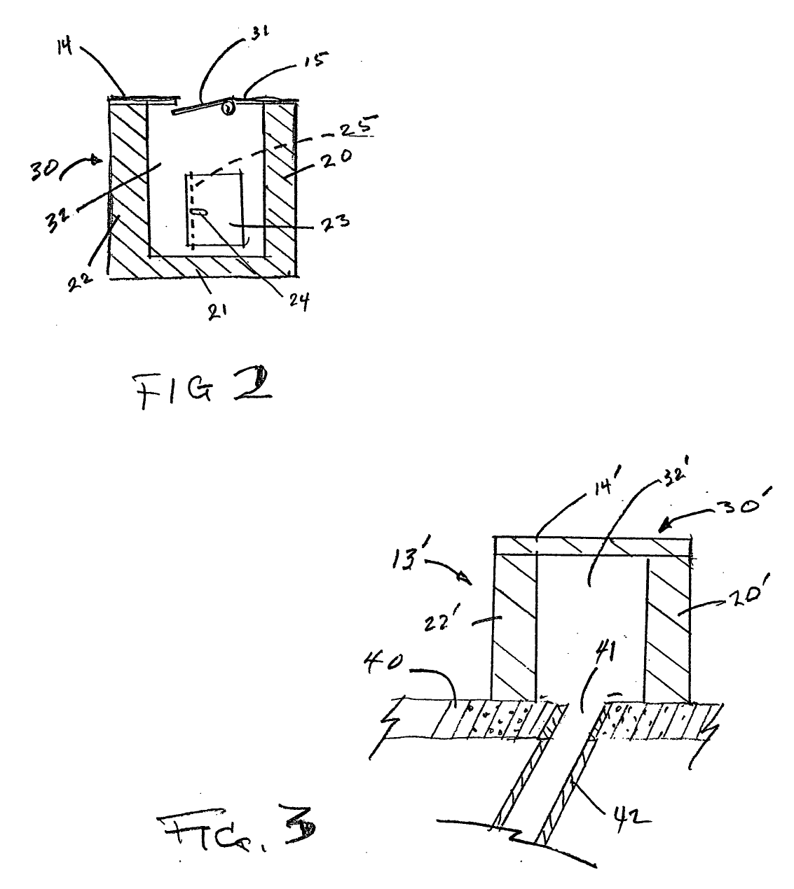

The kiosk 13 provides a brightly marked location advertising the shipping service. As shown, the kiosk 13 has four walls 16, 17, 18 and 19. and a counter-top 14. Within the kiosk, there is a safety depository 30 which can be made to bomb proof specifications with completely enclosing reinforced walls 14, 20, 21, and 22, as shown in FIG. 2. The bottom of the depository 30 may be the floor 40 of the building or a separate reinforced wall 21. With the separate bottom wall 21, the kiosk is portable rather than stationary. The portable kiosk may have wheels (not shown) mounted on the bottom wall 21. A lightweight kiosk may be used that does not include the bomb proof depository but merely a large container of sufficient strength to house and support a large number of packages.

The counter 14 has a blast proof and tamper proof door 31 through which the labeled or packaged items are deposited. As shown, the door 31 is hinged inside the wall 14 to swing inwardly into the depository and is of larger dimensions than the opening in the counter. The door is spring loaded to remain closed when not in use. On one wall of the depository there is a blast proof hatch 23. The hatch is hinged inside and is larger than the opening. An opener 24 operates lugs 25 to unlatch the hatch for access to the interior of the depository. The opener 24 may be a handle or a wheel or other electric or electronic mechanism. The depository provides a secure location for the items until the they are removed, either at scheduled times or randomly, by authorized personnel. The authorized personnel remove the items to a remote location for further processing, for example, proper packaging and labeling. The authorized personnel may then deliver the packages to the addresses given or place the packaged and addressed items with other commercial carriers.

FIG. 3 illustrates a stationary kiosk 13′ that has a safety depository 30′ with a counter 14′ and side walls 20′ and 22′ mounted over an opening 41 in the floor 40 of a building or other structure. A shaft 42 connects the opening 41 with a remote location (not shown). The remote location allows authorized personnel to continuously package and label items and/or place the packaged items with outgoing shipments. Also, the removal of the items from the immediate vicinity of the security check points adds a margin of safety for the people in the terminal or other building.

When the kiosk 13 is manned, the attendant(s) may perform some or all the steps mentioned above with regard to automated functions. The attendant may be required to complete the necessary financial arrangements for purchasing the service. The purchase may be by cash, credit or debit card or other means. The manned or unmanned kiosk may be set up to use a card machine, cash drawer or other payment device connected to the counter top door. The counter top door may have a hinge lock electrically or mechanically connected to the payment device in which case, the door will not open until the financial transaction is complete.

Another possibility for the use of the kiosk is in conjunction with the security personnel manning the security check point. To insure that items found by the security testing machines are removed from the passenger before entering the secure area, the security personnel can take possession of the item and pass it to personnel manning the kiosk. The passenger can then give the shipping instructions to the kiosk personnel. This mode of operation would reduce the number of confiscated items and the man-hours required for handling the storage and disposal of the confiscated items.

Another variation of this scenario involves the security personnel taking possession of the item and tagging the item with an identifying number or mark and giving the passenger a copy of the number or mark. The passenger, if he wishes, may take the copy to the kiosk and make arrangements to ship the marked item. The passenger may then enter the secure area. The marked items may be delivered to the kiosk by the security personnel or the kiosk personnel may pick up the marked items from the security personnel. The numbered items are then shipped to the address given for the corresponding number.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

1. A kiosk for use in association with a security check point permitting deposit of prohibited items for shipment to a desired location, said kiosk comprising an enclosure adapted to store packaging materials and labels providing instructions for shipment, said enclosure having a counter top, a tamper proof door hinged in said counter top, said tamper proof door adapted to permit one-way passage of items into said enclosure.

2. A kiosk of claim 1 wherein said enclosure includes a camera mounted to provide a view of said counter top, said camera operatively connected to a visual recording device, said visual recording device making a permanent record.

3. A kiosk of claim 1 wherein said enclosure includes a microphone operatively connected to an audible recording device, said audible recording device adapted to make a permanent record of instructions.

4. A kiosk of claim 1 wherein said enclosure is portable.

5. A kiosk of claim 1 wherein said enclosure is stationary.

6. A kiosk of claim 5 wherein said enclosure is connected to a shaft, said shaft adapted to pass items for shipment therethrough.

7. A kiosk of claim 1 wherein said tamper proof door is connected to a payment device, whereby operation of said payment device releases said tamper proof door.

8. A kiosk of claim 1 wherein a safety depository is attached inside said enclosure, said depository having reinforced walls, said counter top being reinforced, said tamper proof door accessing the interior of said safety depository.

9. A kiosk of claim 2 Wherein a safety depository is attached inside said enclosure, said depository having reinforced walls, said counter top being reinforced, said tamper proof door accessing the interior of said safety depository.

10. A kiosk of claim 3 wherein a safety depository is attached inside said enclosure, said depository having reinforced walls, said counter top being reinforced, said tamper proof door accessing the interior of said safety depository.

11. The combination of a kiosk and a security check point, said security check point having inspection devices consisting of one of the group of a magnetometer, X-ray equipment, radiation detectors, chemical detectors or biological detectors, said kiosk permitting deposit of prohibited items for shipment to a desired location, said kiosk comprising an enclosure adapted to store packaging materials and labels providing instructions for shipment, said enclosure having a counter top, a tamper proof door hinged in said counter top, said tamper proof door adapted to permit one-way passage of items into said enclosure, said enclosure includes a camera mounted to provide a view of said counter top, said camera operatively connected to a visual recording device, said visual recording device making a permanent record, and said enclosure includes a microphone operatively connected to an audible recording device, said audible recording device adapted to make a permanent record of instructions.

12. The combination of claim 11 wherein a safety depository is attached inside said enclosure, said depository having reinforced walls, said counter top being reinforced, said tamper proof door accessing the interior of said safety depository.

13. A method by which passengers reduce the loss of prohibited items at a security check point comprising the steps of
(a) providing a kiosk adjacent said security check point, said kiosk equipped with devices facilitating shipment of the items,
(b) using said devices to relate the item with the passenger,
(c) using said devices to identify the destination of the item,
(d) completing the financial transaction for shipping the item
(e) preparing said item for shipment,
(f) placing the item in said kiosk and
(g) removing the items from said kiosk and facilitating delivery to said destination.

14. The method of claim 13 including the steps of
(h) providing said kiosk with a counter top,
(i) providing said kiosk with a security depository, and
(j) providing said counter top with a tamper proof door opening into said depository.

15. The method of claim 13 including the steps of
(h) providing said kiosk with a counter top,
(i) providing said counter top with a keyboard connected to a computer capable of printing labels,
(j) inputting instructions to said computer by said keyboard facilitating shipment of the items.

16. The method of claim 13 including the steps of
(h) providing a camera as one of said devices, said camera including means to make a visual permanent record, and
(i) using said camera to visually record the item and the passenger.

17. The method of claim 13 including the steps of
(h) providing a microphone as one of the devices, said microphone including means to make a permanent audible record, and
(i) using said microphone to audibly record the shipping instructions.

18. The method of claim 13 including the steps of
(h) providing a security check point manned by security personnel, said security check point having machines to search for prohibited items,
(i) detecting at least one prohibited item,
(j) said security personnel taking possession of said item,
(k) manning said kiosk with personnel,
(l) said security personnel delivering said prohibited item to said kiosk personnel, and
(m) said kiosk personnel taking possession of said prohibited item for shipment.
